(19) United States
(12) Patent Application Publication
(10) Pub. No.: US 2021/0277196 A1
(43) Pub. Date: Sep. 9, 2021

(54) THERMOPLASTIC COMPOSITES AND CORRESPONDING FABRICATION METHODS AND ARTICLES

(71) Applicant: Solvay Specialty Polymers USA, LLC, Alpharetta, GA (US)

(72) Inventor: Glenn P. DESIO, Marietta, GA (US)

(21) Appl. No.: 17/184,083

(22) Filed: Feb. 24, 2021

Related U.S. Application Data
(60) Provisional application No. 62/985,356, filed on Mar. 5, 2020.

(51) Int. Cl. C08J 5/24; C08G 69/26; B29C 70/22

(52) U.S. Cl. CPC C08J 5/244; C08G 69/26; B29C 70/22; B29K 2077/00; C08J 5/242; C08G 2250/00; C08J 2377/06; C08J 5/243

(57) ABSTRACT

Described herein are thermoplastic composites including a polymer matrix, having an aliphatic polyamide, and at least one continuous reinforcing fiber. Aliphatic polyamides are well suited for the matrix polymer of a thermoplastic composite due to the low viscosity of the polyamide in the melt state enabling impregnation of the fibers. Additionally, the thermal stability of aliphatic polyamides in the melt state allows for ease of consolidation and lamination of the composite fabrics or tapes. The thermoplastic composite having an aliphatic polyamide provides for enhanced strength and stiffness compared to short, discontinuous fiber compounds. Additionally, the thermoplastics composites based on aliphatic polyamides are formable, drapable and, due to the low processing and melting temperature of the polymer matrix, can be injection overmolded with a variety of short fiber compounds.

### CROSS-REFERENCE TO RELATED APPLICATIONS

The present application claims priority to U.S. provisional application No. 62/985,356 filed on Mar. 5, 2020, the content of this application being incorporated herein by reference.

### FIELD OF THE INVENTION

The invention relates to thermoplastic composites including a polymer matrix including an aliphatic polyamide. The invention further relates to the fabrication of thermoplastic composites. The invention still further relates articles incorporating the thermoplastic composites.

### BACKGROUND OF THE INVENTION

Thermoplastic composites are gaining a significant amount of attention as a potential replacement for metal parts. Relative to metal parts, thermoplastic composites can provide a significant reduction in weight and cost, while simultaneously providing desirable or superior mechanical performance. One type of polymer used in thermoplastic composites is polyamides. The popularity of polyamides in thermoplastic composites is at least in part due to the fact that they form crack-free composites. Due to their success to date, thermoplastic composites with polyamide matrices are being investigated for use in a wider variety of application settings, which require greater mechanical performance (e.g. tensile strength) and chemical performance (e.g. chemical resistance). In general, for many of these applications settings, polyamides are able to meet the increased mechanical performance and chemical performance requirements of these new application settings.

### BRIEF DESCRIPTION OF THE DRAWINGS

FIG. 1 is a schematic depiction showing a perspective view of an embodiment unidirectional composite.

FIG. 2 is a schematic depiction showing a perspective view of an embodiment of a multidirectional composite in which the reinforcing fibers are oriented as a woven fabric.

FIG. 3 is a schematic depiction showing a perspective view of an embodiment of a multidirectional composite in which the continuous reinforcing fibers are oriented as a layered fabric.

### DETAILED DESCRIPTION OF THE INVENTION

Described herein are thermoplastic composites including a polymer matrix, having an aliphatic polyamide, and at least one continuous reinforcing fiber. Aliphatic polyamides are well suited for the matrix polymer of a thermoplastic composite due to the low viscosity of the polyamide in the melt state enabling impregnation of the fibers. Additionally, the thermal stability of aliphatic polyamides in the melt state allows for ease of consolidation and lamination of the composite fabrics or tapes. The thermoplastic composite having an aliphatic polyamide provides for enhanced strength and stiffness compared to short, discontinuous fiber compounds. Additionally, the thermoplastics composites based on aliphatic polyamides are formable, drapable and, due to the low processing and melting temperature of the polymer matrix, can be injection overmolded with a variety of short fiber compounds. The composites can be formed using melt impregnation techniques, well known in the art. The composites can be desirably used in a wide range of application settings including, but not limited to automotive, aerospace, oil and gas and mobile electronic device applications.

Unless specifically limited otherwise, the term “alkyl”, as well as derivative terms such as “alkoxy”, “acyl” and “alkylthio”, as used herein, include within their scope straight chain and branched chain moieties. The term “alkyl” does not include cyclic moieties. Examples of alkyl groups are methyl, ethyl, 1-methylethyl, propyl, and 1,1 dimethylethyl. Unless specifically stated otherwise, each alkyl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, or C₆-C₁₅ aryloxy, provided that the substituents are sterically compatible and the rules of chemical bonding and strain energy are satisfied. The term “halogen” or “halo” includes fluorine, chlorine, bromine and iodine, with fluorine being preferred.

### The Polymer Matrix

The polymer matrix includes an aliphatic polyamide and, optionally, at least one additive. The thermoplastic composite includes at least 20 wt. %, at least 25 wt. %, at least 30 wt. %, at least 35 wt. % or at least 40 wt. % of the polymer matrix, relative to the total weight of the composite. Additionally or alternatively, the thermoplastic composite includes no more than 80 wt. %, no more than 70 wt. %, no more than 60 wt. %, no more than 55 wt. %, no more than 50 wt. % or no more than 45 wt. % of the polymer matrix, relative to the total weight of the composite. The person of ordinary skill in the art will recognize additional ranges of the polymer matrix concentration within the explicitly recited ranges above are specifically contemplated and within the scope of the present disclosure.

### The Aliphatic Polyamide

The polymer matrix includes an aliphatic polyamide having a recurring unit (R_{PA}) represented by the following formula:

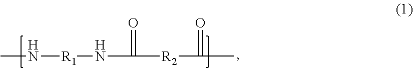

where R₁ is a C₄ to C₄₀ alkyl and R₂ is a C₂ to C₃₈ alkyl, with the proviso that if R₁ is represented by a formula —(CH₂)₅— then R₂ is represented by a formula other than —(CH₂)₈—. In some embodiments, R₁ is selected from the group consisting of C₆ to C₁₂ alkyls, C₁₆ to C₂₀ alkyls and C₂₅ to C₄₀ alkyls. In some embodiments, R₂ is selected from the group consisting of C₄ to C₁₀ alkyls, C₁₄ to C₁₈ alkyls and C₂₃ to C₃₈ alkyls.

Recurring unit (R_{PA}) is formed from the polycondensation of an aliphatic diamine and an aliphatic dicarboxylic acid. More particularly, recurring unit is formed from the polycondensation of an aliphatic diamine and aliphatic dicarboxylic acid represented by the following formulae, respectively: H₂N—R₁—NH₂ and HO—C(═O)—R₂—C(═O)—OH. In some embodiments, the aliphatic diamine is selected from the group consisting of 1,3 diaminobutane, 1,4-diaminobutane, 1,5-diaminopentane, 2-methyl-1,5-diaminopentane, 1,6-diaminohexane, 3-methylhexamethylenediamine, 2,5 dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7 tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12-diaminododecane, 1,13-diaminotridecane and 1,18-diaminooctadecane

In some embodiments, the aliphatic dicarboxylic acid is selected from the group consisting of succinic acid, glutaric acid, 2,2 dimethyl glutaric acid, adipic acid, 2,4,4 trimethyl-adipic acid, pimelic acid, suberic acid, azelaic acid, sebacic acid, undecanedioic acid, dodecandioic acid, tridecanedioic acid, tetradecanedioic acid, pentadecanedioic acid, hexadecanedioic acid and octadecanedioic acid.

In some embodiments, recurring unit (R_{PA}) is formed from the polycondensation of a diamine and dicarboxylic acid according to the following formulae, respectively:

H₂N—(CH₂)ₙ—NH₂,and (2)

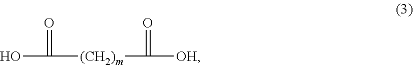

where n is an integer from 4 to 40 and m is an integer from 2 to 38, of course with the aforementioned proviso that if n is 5 then m is other than 8. The person of ordinary skill in the art will recognized that each combination of n and m, within the explicitly defined ranges above, is individually contemplated and within scope of the present disclosure. Preferably, n is from 4 to 40. Preferably, m is from 4 to 38. In one embodiment n is 38. In one embodiment, m is 36. Non-limiting examples of combinations of n and m include, but are not limited to the following (n,m): (4,4), (4,8), (4,16), (4,34), (5,4), (5,10), (5,16), (5,34), (6,4), (6,8), (6,10), (6,16), (10,8), (10,10) and (12,10).

In some embodiments, the aliphatic polyamide is selected from the group consisting of PA 4,6; PA 4,10; PA 4,18; PA 4,36; PA 5,6;PA 5,12; PA 5,18; PA 5,36; PA 6,6; PA 6,10; PA 6,12;PA 6,18; PA 10,10; PA 10,12 and PA12,12.

In some embodiments, the aliphatic polyamide includes at least 50 mol %, at least 55 mol %, at least 60 mol %, at least 70 mol %, at least 80 mol %, at least 90 mol %, at least 95 mol %, at least 99.9 mol % or at least 99.99 mol % of recurring unit (R_{PA}). As used herein, mol % is relative to the total number of recurring units in the indicated polymer (e.g. polyamide), unless explicitly noted otherwise.

In some embodiments, the aliphatic polyamide as an inherent viscosity of at least 0.8 deciliters per gram (“dL/g”). In some embodiments, the aliphatic polyamide has an inherent viscosity of at least 0.9 dL/g or at least 1.0 dL/g. Additionally or alternatively, in some embodiments, the aliphatic polyamide has an inherent viscosity of no more 1.6 dL/g, 1.5 dL/g or 1.4 dL/g.

The aliphatic polyamide can be crystalline or amorphous. As used herein, a crystalline polymer has a heat of fusion (“ΔH_{f}”) of at least 5 Joules per gram (“J/g”), preferably more than 10 J/g. Also, as used herein, an amorphous polymer has a ΔH_{f} of less than 5 J/g, preferably less than 3 J/g. In some embodiments, the polyamide has a ΔH_{f} of no more than 50 J/g, no more than 45 J/g or no more than 40 J/g. ΔH_{f} can be measured according to ASTM D3418 using a heating and cooling rate of 20° C./min. Preferably, the aliphatic polyamide is crystalline.

In some embodiments, the concentration of the aliphatic polyamide in the polymer matrix is at least 50 wt. %, at least 60 wt. %, at least 70 wt. % at least 80 wt. %, at least 90 wt. %, at least 95 wt. % or at least 99.5 wt. %, relative to the total weight of the matrix composition. In some embodiments, the matrix composition can include additional polymers. In some embodiments, the matrix composition can include one or more additional aliphatic polyamides. In one such embodiment, each of the one or more additional aliphatic polyamides is distinctly represented by a formula (1). In embodiments, in which the matrix composition includes one or more additional aliphatic polyamides, (i) the total concentration, in the matrix composition, of the aliphatic polyamide and one or more additional aliphatic polyamides is within the range given above with respect to the aliphatic polyamide or (i) the concentrations, in the matrix composition, of each of the aliphatic polyamide and one or more additional aliphatic polyamides is independently within the range given above with respect to the aliphatic polyamide.

### Additives

In some embodiments, in addition to the at least one aliphatic polymer, the polymer matrix can further include optional additives, including but not limited to, antioxidants (e.g. ultraviolet light stabilizers and heat stabilizers), processing aids, nucleating agents, lubricants, flame retardants, a smoke-suppressing agents, anti-static agents, anti-blocking agents, colorants, pigments, and conductivity additives such as carbon black.

In some embodiments, antioxidants can be particularly desirable additives. Antioxidants can improve the heat and light stability of the polymer matrix in the composite. For example, antioxidants that are heat stabilizers can improve the thermal stability of the composite during manufacturing (or in high heat application settings), for example, by making the polymer processable at higher temperatures while helping to prevent polymer degradation. Additionally, the antioxidants that are light stabilizers can further prevent against polymer degradation during use of the composite application settings where it is exposed to light (e.g. external automobile or aircraft parts). Desirable antioxidants include, but are not limited to, copper salts (e.g. CuO and Cu₂O), alkaline metal halides (e.g. CuI, KI, and KBr, including combinations of alkaline metal halides such as, but not limited to, CuI/KT), hindered phenols, hindered amine light stabilizers (“HALS”) (e.g. tertiary amine light stabilizers) and organic or inorganic phosphorous-containing stabilizers (e.g. sodium hypophosphite or manganese hypophosphite).

In some embodiments, the additive is a halogen-free flame retardant. In some embodiments, the halogen free flame retardant is an organophosphorous compound selected from the group consisting of phosphinic salts (phosphinates), diphosphinic salts (diphosphinates) and condensation products thereof. Preferably, the organophosphorous compound is selected from the group consisting of phosphinic salt (phosphinate) of the formula (4), a diphosphinic salt (diphosphinate) of the formula (5) and condensation products thereof:

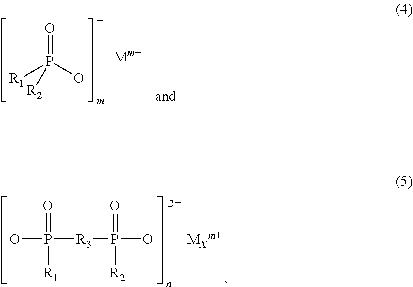

where: R₁ and R₂ are independently selected from a hydrogen or a C₁-C₆ alkyl or an aryl; R₃ is a C₁-C₁₀ alkylene group, a C₆-C₁₀ arylene group, an alkyl-arylene group, or an aryl-alkylene group; M is selected from calcium ions, magnesium ions, aluminum ions, zinc ions, titanium ions, and combinations thereof m is an integer of 2 or 3; n is an integer of 1 or 3; and x is an integer of 1 or 2.

The total concentration of additives in the polymer matrix is 0 wt. %, at least 0.1 wt. %, at least 0.2 wt. %, at least 0.3 wt. %, or at least 0.4 wt. %, relative to the total weight of the polymer matrix. Additionally or alternatively, the total concentration of additives in the polymer matrix is no more than 30 wt. %, no more than 20 wt. %, no more than 10 wt. %, no more than 5 wt. %, no more than 4 wt. %, no more than 3 wt. %, no more than 2 wt. % or no more than 1 wt. %, relative to the total weight of the polymer matrix. The person of ordinary skill in the art will recognize additional ranges of additive concentrations within the explicitly defined ranges above are specifically contemplated and within the scope of the present disclosures.

### The Reinforcing Fibers

The thermoplastic composite includes a continuous reinforcing fiber. As used herein, a continuous reinforcing fiber refers to a fiber having a length, in the longest dimension, of at least 5 mm. In some embodiments, the continuous reinforcing fiber has a length, in the longest dimension, of at least 1 cm, at least 25 cm or at least 50 cm. In some embodiments, the continuous reinforcing fiber has a length of no more than 4 m, no more than 2 m or no more than 1 m. In some embodiments, the continuous reinforcing fiber has a length of from 5 mm to 4 m, from 1 cm to 4 m, from 25 cm to 4 m, from 50 cm to 4 m, from 5 mm to 2 m, from 1 cm to 2 m, from 25 cm to 2 m, from 50 cm to 2 m, from 5 mm to 1 m, from 1 cm to 1 m, from 25 cm to 1 m or from 50 cm to 1 m.

In some embodiments, the continuous reinforcing fiber is selected from the group consisting of, glass fiber, carbon fibers, aluminum fiber, ceramic fiber, titanium fiber, magnesium fiber, boron carbide fibers, rock wool fiber, steel fiber, aramid fiber and natural fiber (e.g. cotton, linen and wood). Preferably, the continuous reinforcing fiber is selected from the group consisting of glass fiber, carbon fiber, aramid fiber, and ceramic fiber.

In some embodiments, the thermoplastic composite includes at least 20 wt. %, at least 25 wt. %, at least 30 wt. %, at least 35 wt. %, at least 40 wt. %, at least 45 wt. %, at least 50 wt. % or at least 55 wt. % of the continuous reinforcing fiber, relative to the total weight of the thermoplastic composite. Additionally or alternatively, in some embodiments the thermoplastic composite includes no more than 80 wt. %, no more than 75 wt. %, no more than 70 wt. %, no more than 65 wt. % or no more than 60 wt. % of the continuous reinforcing fiber, relative to the total weight of the thermoplastic composite. In some embodiments, the thermoplastic composite includes one or more additional continuous reinforcing fibers, each distinct in compositions and as described above. In some such embodiments, the total concentration, in the thermoplastic composite, of the continuous reinforcing fiber and the one or more additional continuous reinforcing fibers is within the ranges given above with respect to the continuous reinforcing fibers. In alternative such embodiments, the concentrations, in the thermoplastic composite, of each of the continuous reinforcing fiber and one or more additional continuous reinforcing fibers is independently within the range given above for the continuous reinforcing fiber.

### The Composites and Composite Fabrication

The composites include the reinforcing fiber impregnated with the polymer matrix. In some embodiments, the composites can be unidirectional composites. In other embodiments, the composite can be a multidirectional composite, in which the fibers have a more complex structure.

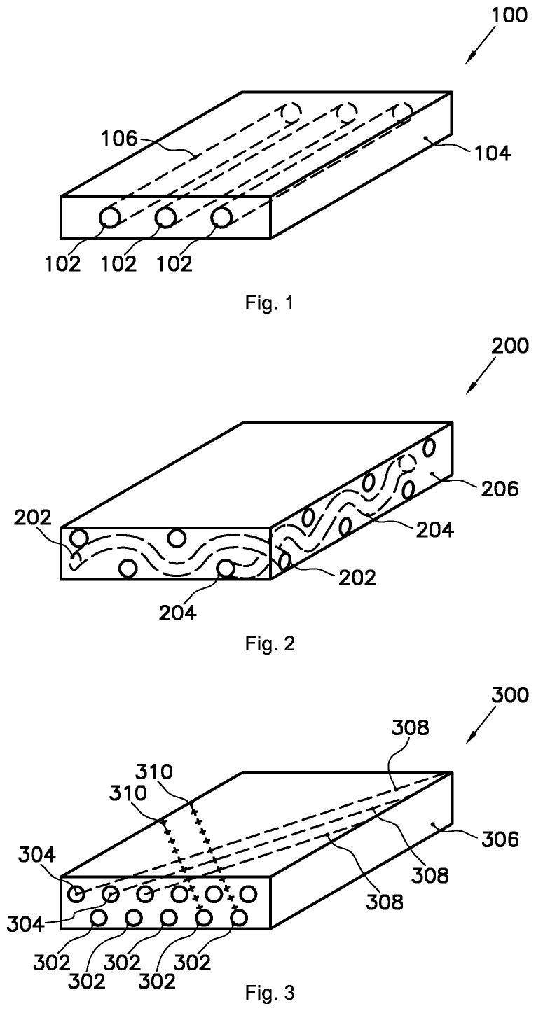

With respect to unidirectional composites (e.g. tapes), the orientation of the reinforcing fibers within the polymer matrix material is generally aligned along the length of the reinforcing fibers (the longest dimensions of the fiber). Unidirectional composites are also sometimes referred to as composite tapes. FIG. 1 is a schematic depiction showing a perspective view of an embodiment unidirectional composite. Referring to FIG. 1, tape 100 includes reinforcing fibers 102 and polymer matrix 104. Reinforcing fibers 102 are generally aligned along their length. Dashed lines 106 (not all labelled, for clarity) denote the orientation of continuous reinforcing fibers 102. As used herein, generally aligned fibers are oriented such that at least 70%, at least 80%, at least 90% or at least 95% of the reinforcing fibers have length that is within 30 degrees, within 25 degrees, within 20 degrees, within 15 degrees, or within 10 degrees along a length of one of the fibers.

In other embodiments, the composite can be a multidirectional composite (e.g. laminate). As noted above, unidirectional composites have fibers that are generally aligned along a single direction. Because the tensile strength of the composite is greater along the length of the fiber, unidirectional composites have excellent tensile strength along a single dimension, and reduced tensile strength along other (e.g. perpendicular) directions. In contrast, multidirectional composites have reinforcing fibers aligned along multiple dimensions and, therefore, have improved tensile strength in multiple dimensions (e.g. more isotropic). In such embodiments, the reinforcing fibers in the polymer matrix can be arranged as a woven fabric or a layered fabric or any combination of one or more therefore. FIG. 2 is a schematic depiction showing a perspective view of an embodiment of a multidirectional composite in which the reinforcing fibers are oriented as a woven fabric. Referring to FIG. 2, multidirectional composite 200 includes polymer matrix 206 and reinforcing fibers 202 and 204, which are generally perpendicular to each other. For clarity, not all reinforcing fibers are labelled in FIG. 2. In some embodiments, each reinforcing fibers 202 and 204 can include bundle of reinforcing fibers. For example, in some embodiments, reinforcing fibers 202 and 204 can be a yarn or layer (e.g. a planar distribution of single reinforcing fibers adjacent each other) of reinforcing fibers. FIG. 3 is a schematic depiction showing a perspective view of an embodiment of a multidirectional composite in which the continuous reinforcing fibers are oriented as a layered fabric. Referring to FIG. 3, multidirectional composite 300 includes reinforcing fibers 302 and 304 and polymer matrix 306. For clarity, not all reinforcing fibers 304 are labelled. Reinforcing fibers 302 and 304 are present in polymer matrix 306 as different layers, with the reinforcing fibers 302 generally aligned parallel with each other and reinforcing fibers 304 generally aligned parallel with each other. Reinforcing fibers 302 are also generally aligned at an angle with reinforcing fibers 304. Dashed lines 308 indicate the alignment of fiber 304 within the multidirectional composite 300. Pluses (“+”) 310 indicate the alignment of fibers 302 within multidirectional composite 300. For clarity, not all fibers 302 and 304 are indicated with dashed lines or pluses. In some embodiments, the angle between fibers 302 and 304 along their respective lengths is at least 15 degrees, at least 30 degrees or at least 40 degrees and no more than about 75 degrees, no more than about 60 degrees or no more than about 50 degrees. Of course, the layered fabric can have additional layers of reinforcing fibers, aligned at the same angle or different angles as the reinforcing fibers in another layer in the multidirectional composite.

The composites can be fabricated by methods well known in the art. In general, regardless of the type of method, composite fabrication includes impregnation of the reinforcing fibers with the polymer matrix material (“melt impregnation”), and subsequent cooling to room temperature (20° C. to 25° C.) form the final solid composite. The melt impregnation includes contacting the reinforcing fibers with a melt of the polymer matrix material. To make the polymer matrix material processable, the melt is at a temperature of at least Tm* to less than Td*, where Tm* is the melt temperature of the aliphatic polyamide in the polymer matrix having the highest melt temperature and Td* is the onset decomposition temperature of the aliphatic polyamide polymer having the lowest onset decomposition temperature in the melt. In some embodiments, melt impregnation can further include mechanical compression of the melt against the fibers. For example, in thermo-pressing, the polymer matrix material is heated to form a melt and mechanically compressed against the fibers simultaneously. In other melt impregnation embodiments incorporating mechanical compression, the fibers can first be contacted with the melt and subsequently mechanically compressed. Subsequent to melt impregnation, the impregnated reinforcing fibers are cooled to form a solid composite. In some embodiments, the composite can be shaped to a desired geometry prior to be cooled to room temperature. In some such embodiments, subsequent to melt impregnation or prior to or during cooling, the impregnated reinforcing fibers can be passed through a die to form the composite having the desired geometry.

One example of a composite fabrication method includes pultrusion. In pultrusion, a plurality of fibers are aligned along their length and pulled in a direction along their length. In some embodiments, the plurality of fibers is delivered from a spool(s) of the reinforcing fiber. To impregnate the fibers, the fibers are pulled through a bath including a melt of the polymer matrix. After being pulled through the melt, in some embodiments, the impregnated fibers can be further heated to further aid in the impregnation. Additionally or alternatively, the impregnated fibers can be pulled through a die and to provide the desired shape to the composite, prior to cooling to room temperature. Pultrusion can be particularly desirable in the formation of unidirectional composites. Another example of a composite fabrication method includes a slurry process. In a slurry process, a slurry is formed by adding the polymer matrix, in powdered form, to a liquid medium to create a suspension. The slurry is coated onto a surface of the fibers, for example, by passing the fibers through a bath of the slurry. Subsequently, the coated fibers are then heated and consolidated (e.g. by heated mechanical rollers). Slurry fabrication can be desirable for the formation of composite tapes. Yet another example of a composite fabrication method involves direct powder deposition. In such a method, the polymer matrix, in powder form, is deposited onto the surface of the fibers and subsequently heated to melt the polymer matrix. Direct powder deposition can be desirable to form woven fabric compositions.

In some embodiments, composited can be formed by thermopressing of a two or more composites. In such embodiments, two or more composites can be thermo-pressed (e.g. heated and mechanically pressed together) to form a new composite. For example, referring to FIG. 3, composite 300 can be formed by thermopressing two unidirectional composites (e.g. composite 100), oriented such the reinforcing fibers of each composite are at the desired angle to one another. As another example, referring to FIG. 2, one or more composites according to composite 200 can be pressed together to form another composite. In some such embodiments, prior to thermopressing, each composite can be oriented to achieve the desired relative fiber alignment between each of the composites being thermopressed.

In some embodiments, the composite can be overmolded with another polymer composition. In some such embodiments, a polymer composition including reinforcing fibers can be injection molded onto a portion of the composite. In such embodiments, the reinforcing fibers generally have a length of less than 5 mm. In one embodiment, a polymer composition including a polyamide and reinforcing glass or carbon fibers can be injection molded onto at least a portion of the thermoplastic composite. The polyamide can be an amorphous or semi-crystalline polyamide, preferably a semi-crystalline polyamide.

### Articles

The thermoplastic composites described herein can be desirably incorporated into articles for use in a wide variety of application settings. With respect to automotive applications, the thermoplastic composites can be integrated into automotive components including, but not limited to, pans (e.g. oil pans), panels (e.g. exterior body panels, including but not limited to quarter panels, trunk, hood; and interior body panels, including but not limited to, door panels and dash panels), side-panels, mirrors, bumpers, bars (e.g., torsion bars and sway bars), rods, suspensions components (e.g., suspension rods, leaf springs, suspension arms), and turbo charger components (e.g. housings, volutes, compressor wheels and impellers). The thermoplastic composites described herein can also be desirably integrated into aerospace components, oil and gas drilling components (e.g. downhole drilling tubes, chemical injection tubes, undersea umbilicals and hydraulic control lines) and mobile electronic device components.

With respect to mobile electronic device components, as used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

In some embodiments, the mobile electronic device component is an antenna housing. In some such embodiments, at least a portion of the radio antenna is disposed on the thermoplastic composite. Additionally or alternatively, at least a portion of the radio antenna can be displaced from the thermoplastic composite. In some embodiments, the mobile electronic device component can be a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device component can be at least a portion of an input device. In some embodiments, the mobile electronic device component can be a housing or a frame (e.g. mobile phone or tablet housing or frame).

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

1. A thermoplastic composite comprising:
a polymer matrix comprising an aliphatic polyamide comprising a recurring unit (R_{PA}) represented by the following formula: 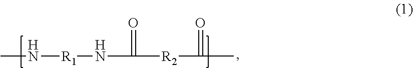
wherein R₁ is a C₄ to C₄₀ alkyl and R₂ is a C₂ to C₃₈ alkyl, with the provision that if R₁ is represented by a formula —(CH₂)₅— then R₂ is represented by a formula other than —(CH₂)₈— and
a continuous reinforcing fiber.

2. The thermoplastic composite of claim 1, wherein recurring unit (R_{PA}) is formed from the polycondensation of a diamine and dicarboxylic acid represented by the following formula, respectively: 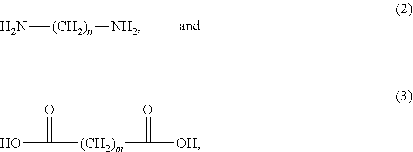
where n is an integer from 4 to 40 and m is an integer from 2 to 38.

3. The thermoplastic composite of claim 2, wherein n and m are selected from a group of (n,m) consisting of: (4,4), (4,8), (4,16), (4,34), (5,4), (5,10), (5,16), (5,34), (6,4), (6,8), (6,10), (6,16), (10,8), (10,10) and (12,10).

4. The thermoplastic composite of claim 1, wherein the concentration of the aliphatic polyamide is at least 50 wt. %, at least 60 wt. %, at least 70 wt. %, at least 80 wt. %, at least 90 wt. %, at least 95 wt. % or at least 99.5 wt. %, relative to the total weight of the polymer matrix.

5. The thermoplastic composite of claim 1, wherein the aliphatic polyamide is crystalline.

6. The thermoplastic composite of claim 1, wherein the polymer matrix comprises an antioxidant.

7. The thermoplastic composite of claim 1, wherein the polymer matrix comprises a halogen free flame retardant.

8. The thermoplastic composite of claim 1, wherein the concentration of polymer matrix in the thermoplastic composite is at least 20 wt. % or no more than 80 wt. %, relative to the total weight of the thermoplastic composite.

9. The thermoplastic composite of claim 1, wherein the continuous reinforcing fiber is selected from the group consisting of glass fibers, carbon fibers and ceramic fibers.

10. The thermoplastic composite of claim 1, wherein the concentration of the reinforcing fibers in the thermoplastic composite is at least 50 wt. % or no more than 70 wt. %, relative to the total weight of the thermoplastic composite.

11. The thermoplastic composite of claim 1, wherein the thermoplastic composite is a unidirectional composite.

12. The thermoplastic composite of claim 1, wherein the reinforcing fibers are oriented as a tape.

13. The thermoplastic composite of claim 1, wherein the thermoplastic composite is a multidirectional composite.

14. The thermoplastic composite of claim 1, wherein the continuous reinforcing fibers are in a configuration selected from the group consisting of a woven fabric, a layered fabric, and a combination thereof.

15. An article comprising the thermoplastic composite of claim 1, wherein the article is selected from the group consisting of an automotive component, an aerospace components, oil and gas drilling components and a mobile electronic device components.
